(19) United States
(12) Patent Application Publication
(10) Pub. No.: US 2026/0029960 A1
(43) Pub. Date: Jan. 29, 2026

(54) LOGICAL ADDRESS INDICATIONS FOR ACCESSING SEQUENTIAL DATA FROM A MEMORY SYSTEM

(71) Applicant: Micron Technology, Inc., Boise, ID (US)

(72) Inventors: Chaohui Liu, Shanghai (CN); Ming Ma, Shanghai (CN)

(21) Appl. No.: 19/260,132

(22) Filed: Jul. 3, 2025

Related U.S. Application Data
(60) Provisional application No. 63/674,697, filed on Jul. 23, 2024.

(51) Int. Cl. G06F 3/06

(52) U.S. Cl. CPC G06F 3/0659; G06F 3/0604; G06F 3/0679

(57) ABSTRACT

Methods, systems, and devices for logical address indications for accessing sequential data from a memory system are described. The described techniques provide for a memory system to access sequential data associated with non-contiguous logical address ranges based on receiving a read command including information indicating the non-contiguous logical address ranges. For example, the read command may indicate the non-contiguous logical address ranges in an extra header segment (EHS) data field and the memory system may use the indication of the non-contiguous logical address ranges to improve access performance, such as by informing a pre-reading algorithm. In some examples, the memory system may identify that the EHS data field includes a logical address table based on one or more second fields of the read command, such as an EHS length field, an EHS type field, and an EHS sub-type field.

### CROSS REFERENCE

The present application for patent claims priority to U.S. patent application Ser. No. 63/674,697 by Liu et al., entitled “LOGICAL ADDRESS INDICATIONS FOR ACCESSING SEQUENTIAL DATA FROM A MEMORY SYSTEM,” filed Jul. 23, 2024, which is assigned to the assignee hereof, and which is expressly incorporated by reference in its entirety herein.

### TECHNICAL FIELD

The following relates to one or more systems for memory, including logical address indications for accessing sequential data from a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports logical address indications for accessing sequential data from a memory system in accordance with examples as disclosed herein.

FIG. 2 shows an example of a process that supports logical address indications for accessing sequential data from a memory system in accordance with examples as disclosed herein.

FIG. 3 shows a block diagram of a memory system that supports logical address indications for accessing sequential data from a memory system in accordance with examples as disclosed herein.

FIG. 4 shows a flowchart illustrating a method or methods that support logical address indications for accessing sequential data from a memory system in accordance with examples as disclosed herein.

### DETAILED DESCRIPTION

Memory systems may be configured to support storing information in one or more memory devices. For example, a memory system may receive one or more write commands indicating to store a set of data to one or more memory devices of the memory system. In some cases, the set of data may be a set of sequential data that is to be stored and/or accessed with respect to an ordering (e.g., a sequence). The write command(s) may include logical addresses, such as logical block addresses (LBAs), associated with the set of data, which may support a host system requesting retrieval of the data by indicating the logical addresses to the memory system (e.g., via one or more read commands). For example, a memory system may store the data to physical addresses (e.g., physical block addresses) of memory in the memory system and may maintain a relationship (e.g., a mapping, a logical-to-physical (L2P) mapping) between the logical and physical addresses, such that the host system may request the data by indicating the logical addresses.

In some examples, a host system may configure logical addresses associated with a set of sequential data to be non-contiguous (e.g., discontinuous, non-sequential). For example, sequential data may be associated with at least a first set of logical addresses (e.g., contiguous logical addresses) and a second set of logical addresses (e.g., contiguous logical addresses), where a starting logical address of the second set may be offset from an ending logical address of the first set (e.g., by one or more logical address indices). A memory system may access the sequential data in response to receiving a read command indicating the logical addresses associated with the sequential data, and, in some cases, may implement a pre-reading technique to improve sequential read performance. For example, a memory system may pre-load a page predicted to follow a currently-read page according to a prediction algorithm configured for the memory system. However, such a prediction algorithm may assume that contiguous LBAs are mapped for sequential data, or may otherwise be adversely impacted by non-contiguous LBAs being associated with a set of sequential data, which may reduce an accuracy of pre-read predictions and introduce additional latency to the system.

In accordance with examples as disclosed herein, a memory system may be configured to support accessing sequential data associated with non-contiguous logical address ranges in response to receiving a read command that includes information indicating the non-contiguous logical address ranges (e.g., an LBA table). For example, a host system may include an indication of non-contiguous logical address ranges in an extra header segment (EHS) data field in a read command, and a memory system may use the indication of the non-contiguous logical address ranges to improve pre-reading performance (e.g., utilizing knowledge of LBA ranges to optimize a pre-read algorithm). In some examples, a memory system may identify that an EHS data field includes an LBA table based on one or more second fields of a read command. For example, a length field may indicate that an EHS field includes data (e.g., is not empty) if the length field includes a value greater than zero. Additionally, or alternatively, an EHS type field, an EHS sub-type field, or both may include information associated with a type of the data included in an EHS data field, such as indicating that the EHS data field includes an LBA table. By identifying non-contiguous logical address ranges included in a read command, a memory system may improve the performance of reading sequential data associated with non-contiguous logical addresses ranges by mitigating latency associated with pre-reading data.

In addition to applicability in memory systems as described herein, techniques for logical address indications for accessing sequential data may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

Features of the disclosure are illustrated and described in the context of systems and architectures. Features of the disclosure are further illustrated and described in the context of a process and flowchart.

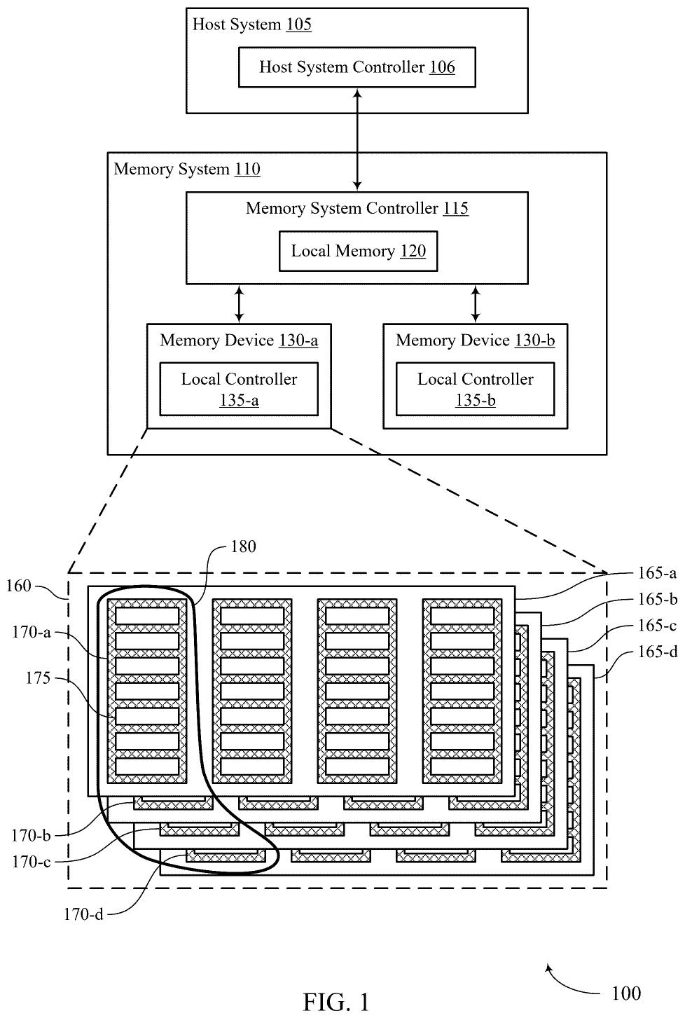

FIG. 1 illustrates an example of a system 100 that supports logical address indications for accessing sequential data from a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples of a system 100, a memory system 110 may receive (e.g., via a memory system controller 115) one or more write commands indicating to store a set of data to one or more memory devices 130 of the memory system 110. The set of data may be a set of sequential data that is to be stored and/or accessed with respect to an ordering (e.g., a sequence). In some cases, a host system 105 may include, in the one or more write commands, a set of logical addresses (e.g., LBAs) associated with a set of sequential data, and the host system 105 may request retrieval of the data by indicating the logical addresses to the memory system 110 via one or more read commands. A memory system 110 may store sequential data to a set of physical addresses, which may be located in a single memory device 130 or may be located in multiple memory devices 130. In some examples, a set of logical addresses associated with a set of sequential data may correspond to one or more non-contiguous logical address ranges (e.g., non-contiguous LBA ranges). For example, sequential data may be associated with a first set of LBAs (e.g., a first range of contiguous LBSs) and a second set of LBAs (e.g., a second range of contiguous LBAs), where a starting LBA of the second set may be offset from an ending LBA of the first set (e.g., by one or more LBA indices). However, non-contiguous LBA ranges being configured for a set of sequential data may reduce a pre-reading performance by the memory system 110, which may introduce additional latency to the system 100.

To support accessing sequential data associated with non-contiguous logical address ranges, a host system 105 (e.g., a host system controller 106) may be configured to include, in a read command, information indicating the non-contiguous logical address ranges, such as in an LBA table. A host system 105 may include an LBA table in an EHS data field of a read command, and a memory system 110 (e.g., a memory system controller 115) may use the LBA table to improve a performance of a pre-reading algorithm (e.g., improve prediction accuracy for pre-loading pages of memory). In some cases, a memory system 110 may identify that an EHS data field includes an LBA table according to values of one or more additional fields in a read command. For example, a memory system 110 may identify that an EHS data field includes data based on a length field having a value greater than zero, and may identify that an EHS data field includes an LBA table based on values of an EHS type field, and EHS sub-type field, or both. Such techniques may improve the performance of a memory system 110 when accessing sequential data associated with non-contiguous LBA ranges, such as by improving a prediction accuracy of a pre-reading algorithm.

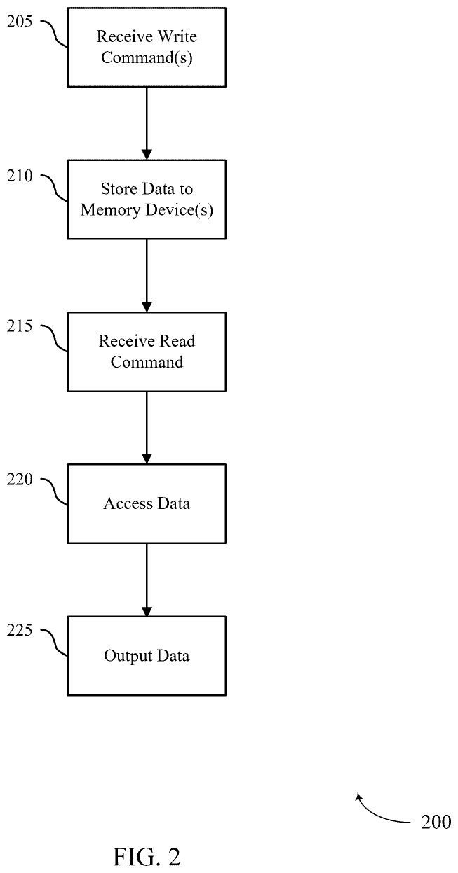

FIG. 2 shows an example of a process 200 that supports logical address indications for accessing sequential data from a memory system in accordance with examples as disclosed herein. The process 200 may implement, or be implemented by, one or more aspects of the system 100. For example, the process 200 may be an example of operations performed by a memory system 110 according to information received from a host system 105. In some cases, the process 200 may support a memory system 110 accessing sequential data associated with non-contiguous LBA ranges using a pre-reading algorithm, which may be enhanced by identifying the non-contiguous LBA ranges in a single read command.

Aspects of the process 200 may be implemented by one or more controllers (e.g., a memory system controller 115, one or more local controllers 135, or a combination thereof), among other components. Additionally, or alternatively, aspects of the process 200 may be implemented as instructions stored in one or more memories (e.g., firmware stored in one or more memories coupled with a memory system 110). For example, the instructions, when executed by one or more controllers (e.g., the memory system controller 115, one or more local controllers 135, or a combination thereof), may cause the one or more controllers (or a device or a system) to perform the operations of the process 200. Alternative examples of the following may be implemented, where some steps are performed in a different order or not at all. Additionally, some steps may include additional features not mentioned below.

At 205, one or more write commands may be received. For example, a memory system 110 (e.g., a memory system controller 115) may receive the one or more write commands. The one or more write commands may indicate to store a set of sequential data to the memory system 110 and may indicate one or more sets of LBAs (e.g., logical addresses) associated with the sequential data. In some examples, the one or more sets of LBAs may include non-contiguous sets of LBAs. For example, the host system 105 (e.g., a host system controller 106) may indicate a first set of one or more LBAs (e.g., contiguous LBAs, a first LBA range) associated with a first portion of the sequential data and a second set of one or more LBAs (e.g., contiguous LBAs, a second LBA range) associated with a second portion of the sequential data, where an ending LBA of the first set may be offset from a starting LBA of the second set (e.g., by one or more LBA indices). In some cases, the host system 105 may configure the sets of LBAs to be non-contiguous in response to various factors, such as a size of the sequential data, an availability of LBA indices at the host system 105, or both, among other examples.

As an illustrative example, information relating to the organization of a set of sequential data (e.g., a file) associated with non-contiguous LBA ranges is provided by Table 1 below:

TABLE 1
Illustrative Set of Sequential Data

| File Offset | Start LBA | End LBA |
|---|---|---|
| 0 | 3475230 | 3475507 |
| 1138688 | 206848 | 207359 |
| 3235840 | 3525412 | 3525473 |
| 3489792 | 3475938 | 3475967 |
| 3612672 | 30062472 | 30062510 |

In the example shown by Table 1, different portions of a file including data may correspond to different LBA ranges. For example, a file offset may indicate which portion of the data is associated with a corresponding LBA range, such as by showing an offset, in bytes, from the beginning of the data (e.g., bytes 0 through 1,138,688 of the data may correspond to LBAs 3,465,230 through 3,475,507, bytes 1,138,688 through 3,325,840 of the data may correspond to LBAs 206,848 through 207,359, and so on). Further, the start LBA and end LBA values may indicate bounds of each LBA range (e.g., each contiguous LBA range), in 4 KB blocks, where the different LBA ranges may be non-contiguous according to an end LBA of a first portion of the data being separate from a start LBA of a second portion of the data (e.g., directly following the first portion) by one or more LBA indices. In the example illustrated by Table 1, a single file of sequential data may be associated with 5 LBA ranges that are not contiguous with one another.

In some cases, mapping non-contiguous LBA ranges to sequential data may result in incompatibility or increased overhead associated with command signaling indicating to read the sequential data. For example, a memory system 110 may receive multiple read commands indicating to access respective portions of the sequential data by indicating respective LBA ranges associated with a portion. Additionally, or alternatively, discontinuous LBA ranges may limit a performance of a pre-reading algorithm, where a memory system 110 may predict a next page of data to load in advance of reading the page.

At 210, data may be stored to one or more memory devices 130. For example, a memory system controller 115 may initiate operations (e.g., commands, to one or more local controllers 135) to store the set of sequential data to physical addresses of one or more memory devices 130 (e.g., in accordance with physical addresses mapped by the memory system 110 to the non-contiguous LBA ranges). In some examples, the memory system 110 may store the set of sequential data to one memory device 130 of the memory system 110 (e.g., the physical addresses may be located within a single memory device 130 of the memory system 110). In some other examples, the memory system 110 may store the set of sequential data to multiple memory devices 130 of the memory system 110 (e.g., the physical addresses may be located within at least a first memory device 130 and a second memory device 130 of the memory system 110). In some examples, storing the set of sequential data may include the memory system 110 appending the sequential data to other data stored to the one or more memory devices 130, overwriting data stored to the one or more memory devices 130 with the set of sequential data, or both. The memory system 110 may store the set of sequential data in physical addresses that are contiguous (e.g., in a physically proximate sequence) or physical addresses that are non-contiguous. In some cases, the memory system 110 may store information indicating a mapping between the LBAs associated with the set of sequential data and the physical addresses that store the set of sequential data (e.g., in an L2P mapping table, as determined by the memory system controller 115).

At 215, a read command may be received. For example, the memory system 110 may receive a read command from the host system 105 requesting the memory system 110 to return at least a portion of the set of sequential data. In some cases, the read command may include information indicating at least a portion of the non-contiguous LBA ranges associated with the set of sequential data. For example, the host system 105 may include an LBA table indicating non-contiguous LBA ranges in an EHS data field of the read command, such that the memory system 110 may identify each set of LBAs associated with the set of sequential data in a single command (e.g., without receiving additional commands indicating respective sets of LBAs for different portions of the sequential data).

In some examples, the memory system 110 may identify that the EHS data field includes the LBA table based on one or more additional fields in the read command associated with the EHS data field. Such fields may be defined in accordance with a memory standard (e.g., a universal flash storage (UFS) standard, where the read command may be an example of a UFS protocol information unit (UPIU)) and may include information related to the EHS data field. For example, the memory system 110 may identify that the EHS data field includes data (e.g., is not empty) based on a length field associated with the EHS data field including a value greater than zero. Additionally, or alternatively, the memory system 110 may identify that the EHS data field includes the LBA table according to an EHS type field, an EHS sub-type field, or both, which may include values indicative that the EHS data field includes LBA information.

In some cases, the LBA table may indicate the non-contiguous LBA ranges by providing the memory system 110 with enough information to derive the non-contiguous LBA ranges. For example, the LBA table may include, for each non-contiguous LBA range, a starting LBA and length value associated with the starting LBA, an ending LBA and a length value associated with the ending LBA, a starting LBA and an ending LBA, or any combination thereof, among other examples. According to the information provided in the LBA table, the memory system 110 may identify the non-contiguous LBA ranges associated with the sequential data (e.g., from a single read command), which may support the memory system 110 accessing the sequential data (e.g., in accordance with a pre-read technique, in accordance with a prefetch technique).

At 220, data may be accessed. For example, the memory system 110 may access the one or more memory devices 130 (e.g., by transmitting one or more commands or other read indications to the memory device(s), from the memory system controller 115) at the physical addresses storing the sequential data. The memory system 110 may access the sequential data from a single memory device 130 or multiple memory devices 130 that store the sequential data. In some cases, accessing the sequential data may be supported or improved due to identifying the non-contiguous LBA ranges included in the EHS data field of the read command. For example, the memory system 110 (e.g., the memory system controller 115, firmware of the memory system 110) may utilize the knowledge of the non-contiguous LBA ranges to inform (e.g., optimize) a pre-reading algorithm, which may improve a prediction accuracy of the pre-reading algorithm and mitigate latency associated with performing the access operation.

At 225, data may be output. For example, the memory system 110 (e.g., the memory system controller 115) may output the set of sequential data in accordance with accessing the one or more memory devices 130. In some examples, the sequential data may be output to a host system 105 (e.g., a host system controller 106) that requested the sequential data via the read command.

Such techniques may improve the performance of the memory system 110 when accessing sequential data associated with non-contiguous LBA ranges, such as by improving a prediction accuracy of a pre-reading algorithm.

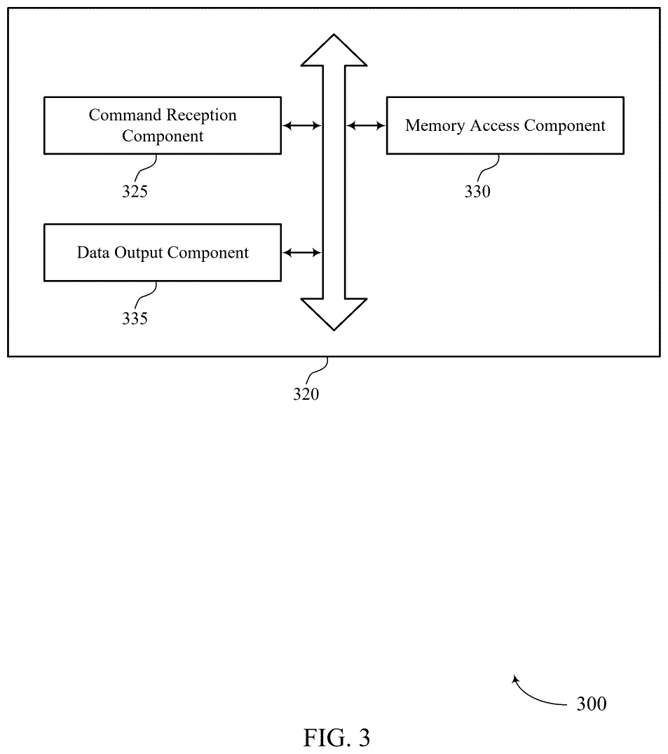

FIG. 3 shows a block diagram 300 of a memory system 320 that supports logical address indications for accessing sequential data from a memory system in accordance with examples as disclosed herein. The memory system 320 may be an example of aspects of a memory system as described with reference to FIGS. 1 through 2. The memory system 320, or various components thereof, may be an example of means for performing various aspects of logical address indications for accessing sequential data from a memory system as described herein. For example, the memory system 320 may include a command reception component 325, a memory access component 330, a data output component 335, or any combination thereof. Each of these components, or components of subcomponents thereof (e.g., one or more processors, one or more memories), may communicate, directly or indirectly, with one another (e.g., via one or more buses).

The command reception component 325 may be configured as or otherwise support a means for receiving a read command indicating a first set of one or more logical addresses and a second set of one or more logical addresses that is non-contiguous with the first set of one or more logical addresses, the first set of one or more logical addresses and the second set of one or more logical addresses associated with a set of sequential data. The memory access component 330 may be configured as or otherwise support a means for accessing one or more memory devices of the memory system 320 at a plurality of physical addresses corresponding to the first set of one or more logical addresses and the second set of one or more logical addresses to retrieve the set of sequential data in response to the read command. The data output component 335 may be configured as or otherwise support a means for outputting the set of sequential data in accordance with accessing the one or more memory devices.

In some examples, the command reception component 325 may be configured as or otherwise support a means for receiving, prior to receiving the read command, one or more write commands indicating to store the set of sequential data in accordance with the first set of one or more logical addresses and the second set of one or more logical addresses that is non-contiguous with the first set of one or more logical addresses. In some examples, the memory access component 330 may be configured as or otherwise support a means for storing the set of sequential data to the plurality of physical addresses of the one or more memory devices, where the plurality of physical addresses include a first set of one or more physical addresses mapped to the first set of one or more logical addresses and a second set of one or more physical addresses mapped to the second set of one or more logical addresses.

In some examples, the plurality of physical addresses are located within a single memory device of the one or more memory devices.

In some examples, the plurality of physical addresses are located within a first memory device of the one or more memory devices and within a second memory device of the one or more memory devices.

In some examples, the first set of one or more logical addresses and the second set of one or more logical addresses are included, within the read command, in an extra header segment (EHS) data field.

In some examples, one or more second fields of the read command indicate that the EHS data field includes the first set of one or more logical addresses and the second set of one or more logical addresses. In some examples, accessing the one or more memory devices in accordance with the first set and the second set is in response to the one or more second fields indicating that the EHS data field includes the first set and the second set.

In some examples, the one or more second fields include a length field, an EHS type field, an EHS sub-type field, or any combination thereof.

In some examples, the first set of one or more logical addresses corresponds to a first set of logical block addresses and the second set of one or more logical addresses corresponds to a second set of logical block addresses.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

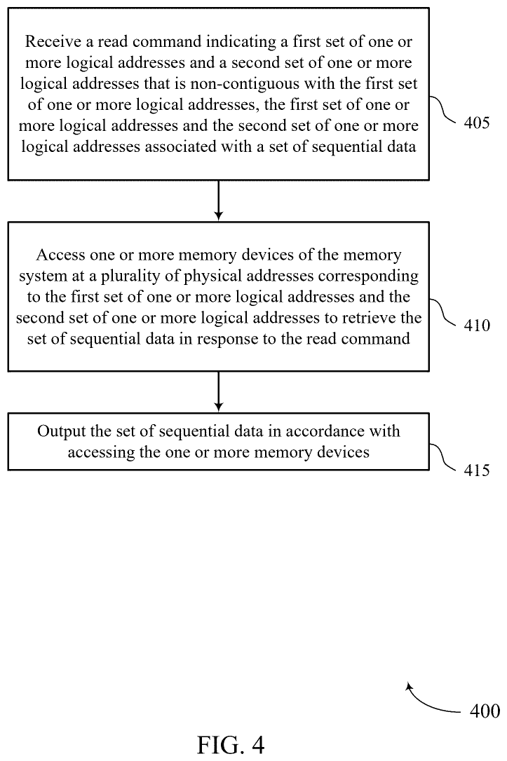

FIG. 4 shows a flowchart illustrating a method 400 that supports logical address indications for accessing sequential data from a memory system in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include receiving a read command indicating a first set of one or more logical addresses and a second set of one or more logical addresses that is non-contiguous with the first set of one or more logical addresses, the first set of one or more logical addresses and the second set of one or more logical addresses associated with a set of sequential data. In some examples, aspects of the operations of 405 may be performed by a command reception component 325 as described with reference to FIG. 3.

At 410, the method may include accessing one or more memory devices of the memory system at a plurality of physical addresses corresponding to the first set of one or more logical addresses and the second set of one or more logical addresses to retrieve the set of sequential data in response to the read command. In some examples, aspects of the operations of 410 may be performed by a memory access component 330 as described with reference to FIG. 3.

At 415, the method may include outputting the set of sequential data in accordance with accessing the one or more memory devices. In some examples, aspects of the operations of 415 may be performed by a data output component 335 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a read command indicating a first set of one or more logical addresses and a second set of one or more logical addresses that is non-contiguous with the first set of one or more logical addresses, the first set of one or more logical addresses and the second set of one or more logical addresses associated with a set of sequential data; accessing one or more memory devices of the memory system at a plurality of physical addresses corresponding to the first set of one or more logical addresses and the second set of one or more logical addresses to retrieve the set of sequential data in response to the read command; and outputting the set of sequential data in accordance with accessing the one or more memory devices.

Aspect 2: The method, apparatus, or non-transitory computer-readable medium of aspect 1, further including operations, features, circuitry, logic, means, or instructions, or any combination thereof for receiving, prior to receiving the read command, one or more write commands indicating to store the set of sequential data in accordance with the first set of one or more logical addresses and the second set of one or more logical addresses that is non-contiguous with the first set of one or more logical addresses and storing the set of sequential data to the plurality of physical addresses of the one or more memory devices, where the plurality of physical addresses include a first set of one or more physical addresses mapped to the first set of one or more logical addresses and a second set of one or more physical addresses mapped to the second set of one or more logical addresses.

Aspect 3: The method, apparatus, or non-transitory computer-readable medium of any of aspects 1 through 2, where the plurality of physical addresses are located within a single memory device of the one or more memory devices.

Aspect 4: The method, apparatus, or non-transitory computer-readable medium of any of aspects 1 through 2, where the plurality of physical addresses are located within a first memory device of the one or more memory devices and within a second memory device of the one or more memory devices.

Aspect 5: The method, apparatus, or non-transitory computer-readable medium of any of aspects 1 through 4, where the first set of one or more logical addresses and the second set of one or more logical addresses are included, within the read command, in an extra header segment (EHS) data field.

Aspect 6: The method, apparatus, or non-transitory computer-readable medium of aspect 5, where one or more second fields of the read command indicate that the EHS data field includes the first set of one or more logical addresses and the second set of one or more logical addresses and accessing the one or more memory devices in accordance with the first set and the second set is in response to the one or more second fields indicating that the EHS data field includes the first set and the second set.

Aspect 7: The method, apparatus, or non-transitory computer-readable medium of aspect 6, where the one or more second fields include a length field, an EHS type field, an EHS sub-type field, or any combination thereof.

Aspect 8: The method, apparatus, or non-transitory computer-readable medium of any of aspects 1 through 7, where the first set of one or more logical addresses corresponds to a first set of logical block addresses and the second set of one or more logical addresses corresponds to a second set of logical block addresses.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive a read command indicating a first set of one or more logical addresses and a second set of one or more logical addresses that is non-contiguous with the first set of one or more logical addresses, the first set of one or more logical addresses and the second set of one or more logical addresses associated with a set of sequential data;
access at least one of the one or more memory devices at a plurality of physical addresses corresponding to the first set of one or more logical addresses and the second set of one or more logical addresses to retrieve the set of sequential data in response to the read command; and
output the set of sequential data in accordance with accessing the at least one of the one or more memory devices.

2. The memory system of claim 1, wherein the processing circuitry is further configured to cause the memory system to:
receive, prior to receiving the read command, one or more write commands indicating to store the set of sequential data in accordance with the first set of one or more logical addresses and the second set of one or more logical addresses that is non-contiguous with the first set of one or more logical addresses; and
store the set of sequential data to the plurality of physical addresses of the one or more memory devices, wherein the plurality of physical addresses comprise a first set of one or more physical addresses mapped to the first set of one or more logical addresses and a second set of one or more physical addresses mapped to the second set of one or more logical addresses.

3. The memory system of claim 1, wherein the plurality of physical addresses are located within a single memory device of the one or more memory devices.

4. The memory system of claim 1, wherein the plurality of physical addresses are located within a first memory device of the one or more memory devices and within a second memory device of the one or more memory devices.

5. The memory system of claim 1, wherein the first set of one or more logical addresses and the second set of one or more logical addresses are included, within the read command, in an extra header segment (EHS) data field.

6. The memory system of claim 5, wherein one or more second fields of the read command indicate that the EHS data field includes the first set of one or more logical addresses and the second set of one or more logical addresses, and wherein accessing the at least one of the one or more memory devices in accordance with the first set and the second set is in response to the one or more second fields indicating that the EHS data field includes the first set and the second set.

7. The memory system of claim 6, wherein the one or more second fields comprise a length field, an EHS type field, an EHS sub-type field, or any combination thereof.

8. The memory system of claim 1, wherein the first set of one or more logical addresses corresponds to a first set of logical block addresses and the second set of one or more logical addresses corresponds to a second set of logical block addresses.

9. A non-transitory computer-readable medium storing code comprising instructions which, when executed by processing circuitry of a memory system, cause the memory system to:
receive a read command indicating a first set of one or more logical addresses and a second set of one or more logical addresses that is non-contiguous with the first set of one or more logical addresses, the first set of one or more logical addresses and the second set of one or more logical addresses associated with a set of sequential data;
access one or more memory devices of the memory system at a plurality of physical addresses corresponding to the first set of one or more logical addresses and the second set of one or more logical addresses to retrieve the set of sequential data in response to the read command; and
output the set of sequential data in accordance with accessing the one or more memory devices.

10. The non-transitory computer-readable medium of claim 9, wherein the instructions, when executed by the processing circuitry of the memory system, further cause the memory system to:
receive, prior to receiving the read command, one or more write commands indicating to store the set of sequential data in accordance with the first set of one or more logical addresses and the second set of one or more logical addresses that is non-contiguous with the first set of one or more logical addresses; and
store the set of sequential data to the plurality of physical addresses of the one or more memory devices, wherein the plurality of physical addresses comprise a first set of one or more physical addresses mapped to the first set of one or more logical addresses and a second set of one or more physical addresses mapped to the second set of one or more logical addresses.

11. The non-transitory computer-readable medium of claim 9, wherein the plurality of physical addresses are located within a single memory device of the one or more memory devices.

12. The non-transitory computer-readable medium of claim 9, wherein the plurality of physical addresses are located within a first memory device of the one or more memory devices and within a second memory device of the one or more memory devices.

13. The non-transitory computer-readable medium of claim 9, wherein the first set of one or more logical addresses and the second set of one or more logical addresses are included, within the read command, in an extra header segment (EHS) data field.

14. The non-transitory computer-readable medium of claim 13, wherein one or more second fields of the read command indicate that the EHS data field includes the first set of one or more logical addresses and the second set of one or more logical addresses, and wherein accessing the one or more memory devices in accordance with the first set and the second set is in response to the one or more second fields indicating that the EHS data field includes the first set and the second set.

15. The non-transitory computer-readable medium of claim 14, wherein the one or more second fields comprise a length field, an EHS type field, an EHS sub-type field, or any combination thereof.

16. The non-transitory computer-readable medium of claim 9, wherein the first set of one or more logical addresses corresponds to a first set of logical block addresses and the second set of one or more logical addresses corresponds to a second set of logical block addresses.

17. A method by a memory system, comprising:
receiving a read command indicating a first set of one or more logical addresses and a second set of one or more logical addresses that is non-contiguous with the first set of one or more logical addresses, the first set of one or more logical addresses and the second set of one or more logical addresses associated with a set of sequential data;
accessing one or more memory devices of the memory system at a plurality of physical addresses corresponding to the first set of one or more logical addresses and the second set of one or more logical addresses to retrieve the set of sequential data in response to the read command; and
outputting the set of sequential data in accordance with accessing the one or more memory devices.

18. The method of claim 17, further comprising:
receiving, prior to receiving the read command, one or more write commands indicating to store the set of sequential data in accordance with the first set of one or more logical addresses and the second set of one or more logical addresses that is non-contiguous with the first set of one or more logical addresses; and
storing the set of sequential data to the plurality of physical addresses of the one or more memory devices, wherein the plurality of physical addresses comprise a first set of one or more physical addresses mapped to the first set of one or more logical addresses and a second set of one or more physical addresses mapped to the second set of one or more logical addresses.

19. The method of claim 17, wherein the plurality of physical addresses are located within a single memory device of the one or more memory devices.

20. The method of claim 17, wherein the plurality of physical addresses are located within a first memory device of the one or more memory devices and within a second memory device of the one or more memory devices.

21. The method of claim 17, wherein the first set of one or more logical addresses and the second set of one or more logical addresses are included, within the read command, in an extra header segment (EHS) data field.

22. The method of claim 21, wherein one or more second fields of the read command indicate that the EHS data field includes the first set of one or more logical addresses and the second set of one or more logical addresses, and wherein accessing the one or more memory devices in accordance with the first set and the second set is in response to the one or more second fields indicating that the EHS data field includes the first set and the second set.

23. The method of claim 22, wherein the one or more second fields comprise a length field, an EHS type field, an EHS sub-type field, or any combination thereof.

24. The method of claim 17, wherein the first set of one or more logical addresses corresponds to a first set of logical block addresses and the second set of one or more logical addresses corresponds to a second set of logical block addresses.
